(19) United States
(12) Patent Application Publication
(10) Pub. No.: US 2011/0106460 A1
(43) Pub. Date: May 5, 2011

(54) AUTOMATED COMPONENT VERIFICATION SYSTEM

(75) Inventors: Ronald Konopacki, Suffield, CT (US); Nathan Carter, Chattanooga, TN (US)

(73) Assignee: ALSTOM Technology Ltd., Baden (CH)

(21) Appl. No.: 12/898,920

(22) Filed: Oct. 6, 2010

Related U.S. Application Data
(60) Provisional application No. 61/257,651, filed on Nov. 3, 2009.

(51) Int. Cl. G01N 3/08; G06F 15/00

(52) U.S. Cl. 702/43; 702/41

(57) ABSTRACT

A system and method are presented for qualifying a component. The system includes a receiving station, a control section, a plurality of test/inspection stations, a data storage section and a marking station. The receiving station receives a component. The control section includes a processor. The plurality of test/inspection stations each include equipment to measure one or more of physical, compositional and resistance properties of the component. The processor and the equipment cooperate to compare the measured properties to predefined properties for acceptance of the component, and to determine conformance between the measured properties and the predefined properties to qualify the component for use. The data storage section includes data store that receives and stores the predefined properties, the unique identifier, and the measured properties of the component. The marking station includes marking equipment to mark the component with the unique identifier.

### CROSS REFERENCE TO RELATED APPLICATIONS

This patent application claims benefit under 35 U.S.C. §119(e) of copending, U.S. Provisional Patent Application Ser. No. 61/257,651, filed Nov. 3, 2009. This patent application also relates to U.S. patent application Ser. No. ______, filed concurrently herewith (attorney docket no. WO9/070-1). The disclosures of these U.S. patent documents are incorporated by reference herein in their entireties.

### BACKGROUND

1. Technical Field

The disclosed subject matter relates to a system and process of self-contained, automated non-destructive examination of components to verify conformity with predefined properties. More particularly, the disclosed subject matter relates to an automated system and process for testing and analyzing components to verify material properties as conforming to predefined requirements, to remove incorrect or non-conforming components from a process, and to uniquely identify the verified and/or non-conforming components and data related thereto.

2. Description of Related Art

In general, incoming components and/or raw material are inspected prior to use in a process to ensure that properties of the components and/or raw material have acceptable properties. In high pressure applications, for example, tubes, pipes and/or other conduits are comprised of materials such as, for example, steel, that is provided from a mill. The mill typically certifies that the components and/or the raw material is of a predefined chemistry, has predefined mechanical properties, and/or is of a predefined structural integrity to ensure suitability for an intended use. Such certification is typically done with various tests such as, for example, by testing with eddy current or ultrasonic means to detect defects or flaws in the components and/or material. Once completed and certified, the certifications are provided to the buyer in the form of a Mill Test Report. The Mill Test Report serves as an official code certification of the components and/or raw material. After arrival from the mill the components and/or raw material is generally inventoried based, in part, on the certification, and stored before entering a production process cycle.

Generally speaking, inspectors assure that components and/or raw material having certain properties are actually retrieved. As with any human interaction, these inspections may be subject to some error such as for example, inadvertently missing a step of or an entire inspection procedure. While there may be quality and other inspection check points, having some overlapping or redundant checks to prevent non-conforming or incorrect components and/or raw material from entering into the production process, most of these checkpoints are also dependant on human interaction. Accordingly, there are several scenarios where components and/or raw material with non-conforming or defective properties could be selected and introduced into the production process. Scenarios include, for example, selecting a component or raw material that is insufficient for the intended use (e.g., a “wrong” component), misplacing components and/or raw materials such that it cannot be found and utilized in the process, or surplus components and/or raw material from another process being inadvertently used in another process rather than being returned to inventory or discarded. Other example problem scenarios include, for example:

1. Components and/or raw material with non-conforming chemical composition but correct physical dimensions inadvertently used in a process;

2. Components and/or raw material with correct chemical composition but with non-conforming physical dimensions used in a process; or

3. Components and/or raw material with insufficient hardness properties or dimensional deficiencies such as, for example, ovality, namely, out of roundness conditions, being used in a process.

In this first scenario, where a component or raw material having a non-conforming chemical composition (e.g., is comprised of a wrong alloy material) for an intended application is utilized and is undetected by inspection processes, a premature failure of the component can result. For example, in an advanced cycle steam generator or petrochemical process, such a premature failure can be costly and, perhaps, catastrophic resulting in a life threatening event to personnel monitoring the process.

In the second scenario, where a component having a non-conforming physical dimension such as, for example, a component is comprised of a material that is undersized in wall thickness, a premature failure may also occur. In the third scenario, where a component's non-conforming physical characteristics can lead to difficulty in, for example, a welding process associated with out of round tubing, premature failure can also occur. Similarly, components with inadequate hardness for an intended process may prematurely fail. As such, if incorrect and non-conforming components and/or raw material are not identified at a start of a production cycle or process, then the incorrect and non-conforming material may well be fabricated as part of a finished component and only detected, if at all, at a final inspection of the finished component resulting in costly rework or scrap of an otherwise finished component.

Additionally, there may be steps in a production process which make detection of non-conformity more difficult. For example, tubes, pipes and/or conduits are often surfaced cleaned by shot blasting. The cleaning process may remove all surface identification marking. Similarly, heat treatment can burn off surface markings. Once such surface identifiers are removed, close differences in the composition (e.g., chemical and/or physical properties) of the tubes, pipes and/or conduits is difficult to detect. For example, tempered ferritic materials are increasingly being used in high temperature application. It is difficult to identify tubes made of such materials only by their physical appearance. As such, components made of various alloys and carbon steel have been confused. As a result, non-conforming components might pass final inspection and shipment.

Accordingly, an improved system and process is desired for automated, non-destructive testing and analyzing of components to verify properties as conforming to predefined requirements, to remove incorrect or non-conforming components from a process, and to uniquely identify the verified and/or non-conforming components and data related thereto.

### SUMMARY

According to aspects illustrated herein, there is provided a system and method for qualifying a component. The method includes receiving a component, assigning a unique identifier to the component, verifying the properties of the component at one or more of a plurality of test, measurement and inspection stations to qualify the component for use. The verifying step may include at least one of verifying physical properties of the component by visually observing and measuring properties of the component, by comparing the observed properties to predefined physical ones of the properties, and by determining conformance between the observed properties and the predefined physical properties. The verifying step may further include at least one of verifying compositional properties of the component by measuring elemental composition of material comprising the component, by comparing the measured elemental composition to predefined compositional ones of the properties, and by determining conformance between the measured elemental composition and the predefined compositional properties. The verifying step may further include at least one of verifying resistance properties of the component by measuring resistance properties of the component, by comparing the measured resistance properties to predefined resistance properties, and by determining conformance between the measured resistance and the predefined resistance properties. The method further includes recording the at least one measured physical, compositional and resistance properties and results of the comparing and determining steps in a data store, and marking the component with the unique identifier.

In one embodiment, the method may include receiving information describing initial properties of the component, and comparing the measured properties to one or both of the predefined properties and the initial properties to qualify the component for use.

According to another aspect illustrated herein, the system includes a receiving station, a control section, a plurality of test/inspection stations, a data storage section and a marking station. The receiving station receives a component. The control section includes a processor. The plurality of test/inspection stations each include equipment to measure one or more of physical, compositional and resistance properties of the component. The processor and the equipment cooperate to compare the measured properties to predefined properties, and to determine conformance between the measured properties and the predefined properties to qualify the component for use. The data storage section includes data store that receives and stores the predefined properties, the unique identifier, and the measured properties of the component. The marking station includes marking equipment to mark the component with the unique identifier. In one embodiment, the receiving station receives information describing initial properties of the component, and the processor and the equipment of one or more of the plurality of test/inspection stations cooperate to compare the measured properties to one or both of the predefined properties and the initial properties to qualify the component for use.

The above described and other features are exemplified by the following figures and detailed description.

### BRIEF DESCRIPTION OF THE DRAWINGS

Referring now to the figures, which are exemplary embodiments, and wherein the like elements are numbered alike.

FIG. 1 illustrates an automated component verification system according to one embodiment disclosed herein.

FIG. 2 illustrates a vision testing station of the verification system according to one embodiment disclosed herein.

FIG. 3 illustrates a component marked with a unique identifier according to one embodiment disclosed herein.

FIG. 4 depicts a report highlighting information, data and status of tests performed by the verification system according to one embodiment disclosed herein.

FIG. 5 depicts a report highlighting results of tests and/or procedures performed by the verification system according to one embodiment disclosed herein.

### DETAILED DESCRIPTION

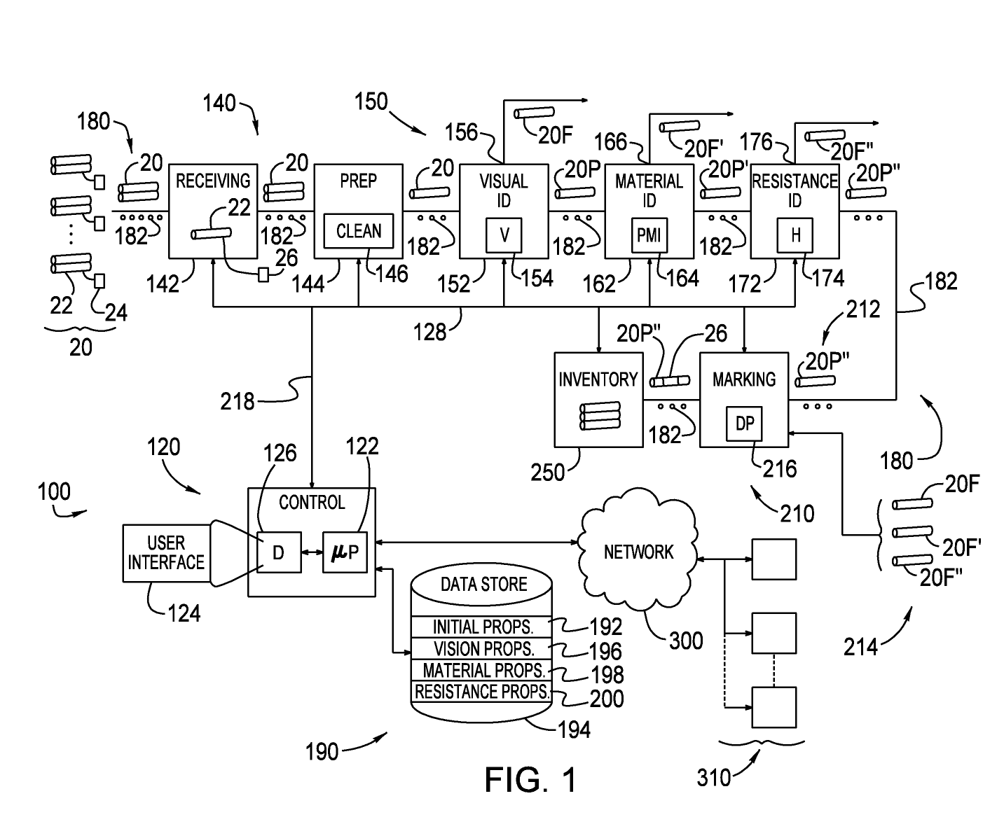

FIG. 1 illustrates an automated component verification system 100 that validates properties of components and/or raw material including, for example, material or chemical composition, physical properties such as dimensions, roundness and like properties, structural or resistance properties such as hardness and the resistance to penetration, scratching, wear or abrasion and like properties, to qualify the components and/or raw material for use within a production process. As shown in FIG. 1, the verification system 100 includes a control section shown generally at 120, a test/inspection section shown generally at 140, a transport section shown generally at 180, a data storage section shown generally at 190, and a marking section shown generally at 210. Each section 120, 140, 180, 190 and 210 is operatively connected to process one or more components and/or raw materials 20 received at the verification system 100. For purposes of illustration only, and not intended to the limited the disclosed subject matter, the one or more components and/or raw materials are hereinafter referred to as tubes, pipes or conduits 20, to be qualified for use in an industrial process. It should be appreciated that it is within the scope of the present disclosure that the verification system 100 described herein may process other components and/or raw materials individually or in various combinations.

As shown in FIG. 1, the tubes 20 are provided to a receiving station 142 of the test/inspection section 140 by material transport equipment 182 of the transport section 180. In one embodiment, the material transport equipment 182 includes, for example, a conveyor or other “drive-through” or “push-pull” type transport devices, operating by manual or automatic control. For example, a processor 122 of the control section 120 controls transport of the tubes 20 by the transport equipment 182 to the receiving station 142 and to other locations within the test/inspection section 140. Alternatively, the processor 122 may signal an operator to manually transport the tubes 20 to the receiving station 142 and to other locations within the test/inspection section 140 by conventional means. In yet another embodiment, the material transport equipment 182 may provide liquid transport of the tubes 20 or other components and/or raw materials to be verified within the test/inspection section 140. In one embodiment, the processor 122 may be implemented as, for example, a standalone or networked, general purpose computer, work station, and portable computing device such as, for example, a laptop or tablet computer or the like, capable of running an operating system such as one of the Microsoft Windows family of operating systems from Microsoft Corporation of Redmond, Wash. (USA), the Macintosh operating system from Apple Computer of Cupertino, Calif. (USA), and various varieties of Unix, such as Sun Solaris from Sun Microsystems, and Linux from Red Hat, Inc. of Durham, N.C. (USA), and others.

At the receiving station 142, information describing the tubes 20 is input into the verification system 100, for example, by the operator or otherwise provided to the verification system 100 by an authorized person responding to requests for input at a user interface 124 exhibited at a display device 126 coupled to the processor 122. In one embodiment, the tubes 20 are received in predetermined lots or bundles such as, for example, bundle 22. Each bundle 22 has associated information 24 provided on the bundle 22 (e.g., labeled or written thereon) or provided as documentation accompanying the bundle 22 (e.g., in a same shipping container or the like). The information 24 includes characteristics and/or properties of each of the tubes 20 and/or the bundle 22 as a whole such as, for example, a tube bundle identification code or number, quantity of tubes with the bundle 22, weight of the bundle 22 and/or each tube 20, and the like. The information 24 may include properties of tubes 20 such as, for example, the chemical composition, physical dimensions, structural or resistance properties and the like, of each respective one of the tubes 20 provided by the source of the tubes such as, for example, the aforementioned Mill Test Report provided by a mill supplying the tubes 20.

Alternatively, the information 24 may be provided to the verification system 100 and the properties of the tubes 20 retrieved by the processor 122. In one embodiment, for example, the processor 122 receives the tube bundle identification code provided via the user interface 124 and accesses a record 192 within a data base 194 of the data storage section 190. The record 192 includes the properties of the tubes 20 associated with the tube bundle identification code. In one embodiment, the record 192 is received and stored at the data base 194 before, contemporaneously with, or in advance of receipt of the tube bundle 22. In another embodiment, the processor 122 includes communications capabilities for accessing a network 300 such as, for example, an intranet, extranet, the internet or like communication network, to retrieve the properties of the tubes 20 from one or more remotely located processing systems and data sources therein, shown generally at 310. In one embodiment, the remotely located processing systems 310 include the supplier (e.g., the mill) that provided the tubes 20.

At the receiving station 142, the properties of the tubes 20 are initially processed by the verification system 100. In one embodiment, the processor 122 assigns each of the tubes 20 a unique tube identification number 26. The tube identification number 26 may be stored by the processor 122 on the record 192 associated with each of the tubes 20. In one embodiment, the properties of the tubes 20 include material composition, inside and outside diameters for tubular components, weight, and the like. As described below, the information 24 defines initial properties for identifying the tubes 20 which may or may not be later confirmed or invalidated by subsequent test and inspection procedures performed by the verification system 100. Once the initial properties are determined, the tubes 20 are passed by the material transport equipment 182 to a preparation station 144. At the preparation station 144, surfaces of the tubes 20 are prepared or cleaned by, for example, a shot blast process, sanding or the like, performed at 146, in preparation for further testing, inspection and analysis. The cleaning process typically removes any identification information written or otherwise applied to surfaces of the tubes. Testing, inspection and analysis processes are now undertaken at a plurality of test, measurement and inspection stations 150 to verify and confirm or invalidate that properties of the tubes 20 are acceptable for use. For example, the plurality of test, measurement and inspection stations 150 verify that measured or observed properties of the tubes 20 (as described below) conform to predefined properties of a subject process.

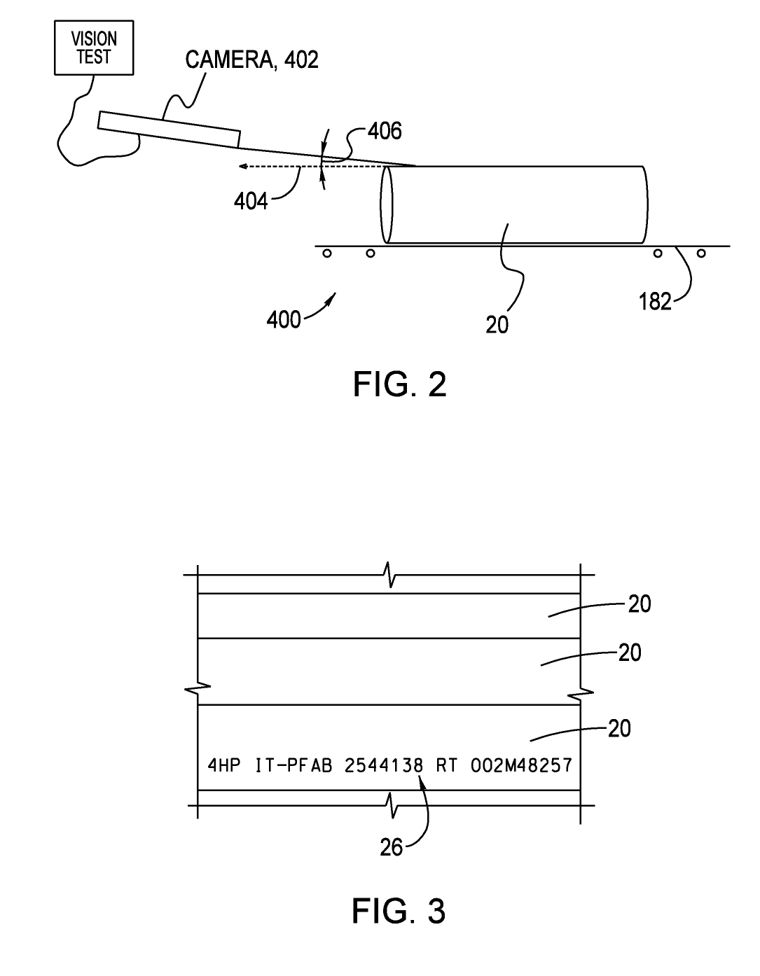

The plurality of test, measurement and inspection stations 150 include a vision testing station 152. The vision testing station 152 observes or measures, and confirms, verifies, validates or invalidates, for example, physical properties or attributes (e.g., dimensions) of the tubes 20. The physical properties of the tubes may include, for example, inside diameter (ID), outside diameter (OD), concentricity and/or roundness of tubular components, wall thickness and other physical dimensions. In one embodiment, one or more of the physical properties is calculated based upon visually observed characteristics of the tubes 20, for example, wall thickness being calculated as a difference between the measured OD and ID. The resulting measurements, readings and the like, of the tested physical properties are stored by the verification system 100. In one embodiment, for example, the data record 192 including the initial properties of the tubes 20 is accessed by the processor 122 and provided to equipment (V) 154 at the vision testing station 152. The equipment 154 may include, for example, a digital or optical camera, laser gauging system, and related processors and components such as a vision system available from Cognex Corporation of Natick, Mass. (USA). In one embodiment, illustrated in FIG. 2, a camera 402 of a vision testing station 400 is mounted above and at a predefined angle 406 to a path of travel 404 of the tubes 20 through the vision testing station 400. In one embodiment, the predefined angle 406 is about thirty degrees (30° with respect to the path of travel 404. At least one perceived benefit of mounting the camera 402 at the angle 406 is that the angled point of view of the camera 402 facilitates detection of edges of the tubes 20 and more reliable determination of, for example, wall thickness and the like. The angled mounting also facilitates passage of the tubes 20 beneath the camera 402 as the tubes 20 traverse the path of travel 404.

Conforming and non-conforming data values are recorded by the equipment 154. In one embodiment, conforming data values represent correspondence of the measured physical properties to predefined properties of the tubes 20 that are acceptable for use within a subject process or product, within allowable deviations between measured and predefined values (e.g., tolerance ranges), as predefined in or supplied to the equipment 154. In another embodiment, conforming data values represent correspondence of the measured physical properties to the initial properties of the tubes 20, within allowable deviations between measured and initial data values (e.g., tolerance ranges), as predefined in or supplied to the equipment 154. In one embodiment, the processor 122 creates a new data record 196 in the data store 194 including the resulting measurements, readings and the like, of the physical properties of the tubes 20 determined by the vision testing station 152. The new data record 196 may include some or all of the data values of the associated predefined acceptable properties and the initial properties of the tubes 20 (e.g., on record 192) or may include a reference, link or the like, to the associated initial properties stored in the data base 194 (e.g., a reference to the record 192). Accordingly, one or all of the initial properties (e.g., the record 192), the predefined acceptable properties, and the resulting measurements and readings determined by the vision testing station 152 (e.g., the record 196) are available within the verification system 100. In one embodiment, the conforming and non-conforming data values are determined by exercising one or more predefined vision testing procedures and comparing the measured values to the predefined acceptable properties as defined by the procedures, with and without allowable deviations between actual and requisite values (e.g., tolerance ranges), also defined by the procedures.

Based on the procedures and comparisons of the measured values for properties to one or both of the initial values for properties and the requisite values for the predefined acceptable properties, one or more tubes 20 may “pass” or “fail” in accordance with the predefined vision testing procedure. In one embodiment, the processor 122 provides the vision testing procedures to personnel operating and/or monitoring the equipment 154 stationed at the vision testing station 152. The procedures may include one or more steps to be performed, properties to be measured and predefined requisite data values and ranges thereof. In one embodiment, the processor 122 monitors operation at the vision testing station 152 to ensure each step of the vision testing procedure is completed or, if not performed, the non-performance is authorized and recorded.

In one embodiment, one or more of the initial properties (e.g., data from the record 192), the resulting measurements and readings taken of the physical properties by the vision testing station 152 (e.g., the actual measurements performed at one or more steps) and the predefined requisite values or ranges of values for the predefined acceptable properties from the testing procedure, are stored on the record 196 and available within the verification system 100.

As shown in FIG. 1, one or more of the tubes 20 may “fail” the testing procedures at the vision testing station 152. The tubes that “fail” the testing procedures, hereinafter tubes 20_{F}, are directed off-line at, for example, output 156 of the vision testing station 152. In one embodiment, these failed tubes 20_{F} may be more closely examined (e.g., manually examined by trained personnel), re-worked or otherwise processed at the output 156 to determine whether they may be used with a production process, returned to the source providing the failed tubes 20_{F} to the verification system 100, or discarded. In one embodiment, the record 196 is updated to reflect any information, data or status recorded by the personnel when examining, re-working or otherwise processing the tubes 20_{F}. The tubes 20 that “pass” the testing procedures, hereinafter tubes 20_{P}, performed at the vision testing station 152 are directed to additional ones of the plurality of test, measurement and inspection stations 150 by the material transport equipment 182. In one embodiment, at least one of the tubes that pass (e.g., the tubes 20_{P}) and the tubes that fail (e.g., the tubes 20_{F}) are ranked based on, for example, a degree in which the tubes conform or do not conform to the predefined properties. One or more qualifications for use may be based on the tubes 20 overall rating among other tubes 20. For example, higher or highest ranking tubes 20 may be used in more critical or sensitive process such as in processes conducted under high pressure and the like. Similarly, lower or lowest ranking tubes 20 may be used in less critical processes or at a location on an assembly or within a process where more regular replacement is more readily made and accepted.

The tubes 20_{P} that passed the procedures at the vision testing station 152 are passed to a material identification station 162 of the plurality of test, measurement and inspection stations 150. The material identification station 162 measures and confirms, verifies, validates or invalidates, for example, compositional properties (e.g., chemical and material composition) of the tubes 20_{P}. The compositional properties of the tubes may be determined, for example, by spectral analysis. The resulting measurements, readings and the like, of the tested compositional properties are stored by the verification system 100. In one embodiment, for example, the data record 192 including the initial properties of the tubes 20 is accessed by the processor 122 and provided to equipment 164 at the material identification station 162. The equipment 164 may include, for example, one or more Positive Material Identification (PMI) devices such as a handheld x-ray fluorescence (HHXRF) device from Innov-X Systems, Inc. of Woburn, Mass. (USA). In one embodiment, the equipment 164, e.g., the HHXREF device, measures elemental composition of the material of the tubes 20_{P} to verify and/or invalidate conformity to the initial properties of the tubes 20 and/or the predefined requisite values or ranges of values from testing procedure of the material identification station 162, described below.

Conforming and non-conforming data values are determined by the equipment 164. In one embodiment, conforming data values represent correspondence of the measured compositional properties to predefined properties of the tubes 20 that are acceptable for use within a subject process or product, within allowable deviations between measured and the predefined properties (e.g., tolerance ranges), as predefined or supplied to the equipment 164. In another embodiment, conforming data values represent correspondence of the measure compositional properties to the initial properties of the tubes 20, within allowable deviations (e.g., tolerance ranges), as predefined in or supplied to the equipment 164. In one embodiment, the processor 122 creates a new data record 198 in the data store 194 including the resulting measurements, readings and the like, of the compositional properties of the tubes 20_{P} tested at the material identification station 162. The new data record 198 may include some or all of the data values of the associated predefined acceptable properties and the initial properties of the tubes 20_{P} (e.g., on record 192), the resulting measurements and readings taken of the physical properties by the vision testing station 152 (e.g., the record 196), or may include references, links or the like, to the associated records stored in the data base 194. Accordingly, one or more of the predefined acceptable properties, the initial properties (e.g., the record 192), the resulting measurements and readings taken of the physical properties by the vision testing station 152 (e.g., the record 196), and the resulting measurements and readings taken of the compositional properties by the material identification station 162 (e.g., the record 198), are available within the verification system 100.

In one embodiment the conforming and non-conforming data values are determined by exercising predefined material identification testing procedures and comparing the actual measured values for properties to requisite values for the predefined acceptable properties as defined by the testing procedures, with and without allowable deviations between the measured and the requisite values (e.g., tolerance ranges), as defined by the procedures. For example, the equipment 164 (the HHXREF device) may be preload or programmed with information for detecting known alloys (e.g., spectral analysis thereof). Based on the procedures and comparisons of the measured values for properties to one or both of the initial values for properties and the requisite values for the predefined acceptable properties, one or more tubes 20_{P} may “pass” or “fail” in accordance with the predefined material identification testing procedure. In one embodiment, the processor 122 provides the material identification testing procedures to authorized personnel operating and/or the equipment stationed at the material identification testing station 162. The procedures may include one or more steps to be performed, properties to be measured and predefined requisite data values and ranges thereof. In one embodiment, the processor 122 monitors operation at the material identification testing station 162 to ensure each step of the material identification test procedure is completed or, if not performed, the non-performance is authorized and recorded. Once again, in one embodiment, at least one of the tubes that pass (e.g., the tubes 20_{P}′) and the tubes that fail (e.g., the tubes 20_{F}′) are ranked based on, for example, a degree in which the tubes conform or do not conform to the predefined properties. One or more qualifications for use may be based on the tubes' overall rating among other tubes 20.

As shown in FIG. 1, the tubes 20_{P} that “fail” procedures, hereinafter tubes 20_{F}′, at the material identification testing station 162 are directed off-line at, for example, output 166. In one embodiment, these failed tubes 20_{F}′ may be more closely examined (e.g., manually examined by trained personnel), re-worked or otherwise processed at the output 166 to determine whether they may be used with a production process, returned to the source providing the failed tubes 20_{F}′ to the verification system 100, or discarded. In one embodiment, the record 198 is updated to reflect any information, data or status recorded by the personnel when examining, re-working or otherwise processing the tubes 20_{F}′. Tubes that “pass” the procedures, hereinafter tubes 20_{P}′, at the material identification station 162 are directed to additional ones of the plurality of test, measurement and inspection stations 150 by the material transport equipment 182.

For example, the tubes 20_{P}′ that passed the procedures at the material identification testing station 162 are passed to a material resistance testing station 172 of the plurality of test, measurement and inspection stations 150. The material resistance testing station 172 measures and confirms, verifies, validates or invalidates, for example, resistance properties of the material that allow it to resist scratching, deformation and the like, such as the hardness, tensile strength, and the like, of the tubes 20_{P}′. The resulting measurements, readings and the like, of the tested resistance properties are stored by the verification system 100. In one embodiment, for example, the data record 192 including the initial properties of the tubes 20 is accessed by the processor 122 and provided to equipment 174 at the material resistance testing station 172. The equipment 174 may include, for example, an automated hardness testing device to measure hardness of the tubes 20_{P}′ from Zwick Roell of Kennesaw, Ga. (USA). For example, an area of each of the tubes 20_{P}′ is cleaned and the automated hardness testing device 174 indexes down, contacts the area and senses or measures the hardness of the subject tube.

As with aforementioned testing and measuring procedures, conforming and non-conforming data values are determined by the equipment 174. In one embodiment, conforming data values represent correspondence of the measured resistance properties to predefined properties of the tubes 20 that are acceptable for use within a subject process or product, within allowable deviations between the measured and the initial properties (e.g., tolerance ranges) as predefined in or supplied to the equipment 174. In another embodiment, conforming data values represent correspondence of the measure resistance properties to the initial properties of the tubes 20, within allowable deviations between the measured and the initial properties (e.g., tolerance ranges) as predefined in or supplied to the equipment 174. In one embodiment, the processor 122 creates a new data record 200 in the data store 194 including the resulting measurements, readings and the like, of the resistance properties of the tubes 20_{P}′ tested at the material resistance testing station 172. The new data record 200 may include some or all of the data values of the associated predefined acceptable properties and the initial properties of the tubes 20_{P}′ (e.g., on record 192), the resulting measurements and readings taken of the physical properties by the vision testing station 152 (e.g., the record 196), the resulting measurements and readings taken of the compositional properties by the material identification station 162 (e.g., the record 198), or may include references, links or the like, to the associated records stored in the data base 194. Accordingly, one or more of the predefined acceptable properties and the initial properties (e.g., the record 192), the resulting measurements and readings taken of the physical properties by the vision testing station 152 (e.g., the record 196), the resulting measurements and readings taken of the compositional properties by the material identification station 162 (e.g., the record 198), and the resulting measurements and readings taken of the resistance properties by the material resistance testing station 172 (e.g., the record 200), are available within the verification system 100.

In one embodiment the conforming and non-conforming data values are determined by exercising predefined material resistance testing procedures and comparing the measured data values for properties to predefined requisite data values for the defined acceptable properties, with and without allowable deviations between the measured and the requisite data values, as defined by the procedures. Based on the procedures and comparisons of the measured values for properties to one or both of the initial values for properties and the requisite values for the acceptable properties, one or more tubes 20_{P}′ may “pass” or “fail” in accordance with the predefined material resistance testing procedure. In one embodiment, the processor 122 provides the material resistance testing procedures to authorized personnel operating and/or the equipment 174 stationed at the material structural testing station 172. The procedures may include one or more steps to be performed, properties to be measured and predefined requisite data values and ranges thereof. In one embodiment, the processor 122 monitors operation at the material resistance testing station 172 to ensure each step of the material resistance testing procedure is completed or, if not performed, the non-performance is authorized and recorded. As above, in one embodiment, at least one of the tubes that pass (e.g., the tubes 20_{P}″) and the tubes that fail (e.g., the tubes 20_{F}″) are ranked based on, for example, a degree in which the tubes conform or do not conform to the predefined properties. One or more qualifications for use may be based on the overall rating. In one embodiment, where one or more tubes 20 may be combined for example, in an assembly, the ratings of the one or more tubes may be summed and totaled to provide a ranking suitable for qualifying the assembly for certain uses. For example, a high ranked assembly may be used in critical or highly sensitive applications or processes and a lower ranked assembly may be used in less critical applications or in locations were replacement of the assembly is easier.

As shown in FIG. 1, the tubes 20_{P}′ that “fail” procedures, hereinafter tubes 20_{F}″, at the material resistance testing station 172 are directed off-line at, for example, output 176. In one embodiment, these failed tubes 20_{F}″ may be more closely examined (e.g., manually examined by trained personnel), re-worked or otherwise processed at the output 176 to determine whether they may be used with a production process, returned to the source providing the failed tubes 20_{F}″ to the verification system 100, or discarded. In one embodiment, the record 200 is updated to reflect any information, data or status recorded by the personnel when examining, re-working or otherwise processing the tubes 20_{F}″. Tubes that “pass” the procedures, hereinafter tubes 20_{P}″, at the material resistance testing station 172 may be directed to additional ones of the plurality of test, measurement and inspection stations 150 by the material transport equipment 182.

Once procedures at the plurality of test, measurement and inspection stations 150 have been completed, the tubes 20 received by the verification system 100 have been categorized into a first set of tubes 212, for example, the tubes 20_{P}″, having properties, attributes and/or characteristics that conform to predefined requirements of a process (e.g., tubes that qualify for use in the process), and a second set of tubes 214 including, for example, the tubes 20_{F}, 20_{F}′ and 20_{F}″, having properties, attributes and/or characteristics that do not conform to the predefined requirements of the process (e.g., tubes that do not currently qualify for use in the process). In one embodiment, one or both of the sets 212 and 214 of conforming and non-conforming tubes are directed to the marking station 210 of the verification system 100. At the marking station 210 the conforming and/or non-conforming tubes are marked with a unique identification by the processor 122. For example, the processor 122 initiates a marking process to mark, or otherwise present, the tube identification number 26 on each of the tubes 20. In one embodiment, illustrated in FIG. 3, the marking process includes, for example, applying the unique identification, e.g., the tube identification number 26, to the tubes 20 as a two-dimensional (2D) machine readable bar code, human readable alpha numeric code, or the like identification format, by equipment 216 performing a dot peen process at a predetermined or at various locations along a length of the tubes 20. In one embodiment, the dot peen equipment 216 indents the OD of each tube 20 a depth of about less than 0.006 inch (0.152 mm) in a round configuration to avoid producing a stress on the tube which may contribute to material failure. In one embodiment, the marking process is performed by a dot peen marking system from SIC Marking Corp. of Allison Park, Pa. (USA). In another embodiment, the marking process may include other equipment such as, for example, ink jet printing or a similar painting system.

Once marked, the conforming tubes, e.g., the tubes 20_{P}″ may be passed from the marking station 210 directly to a subject production process, product or to an area 250 where the tubes 20_{P}″ may be placed in inventory to await subsequent use in the process or product.

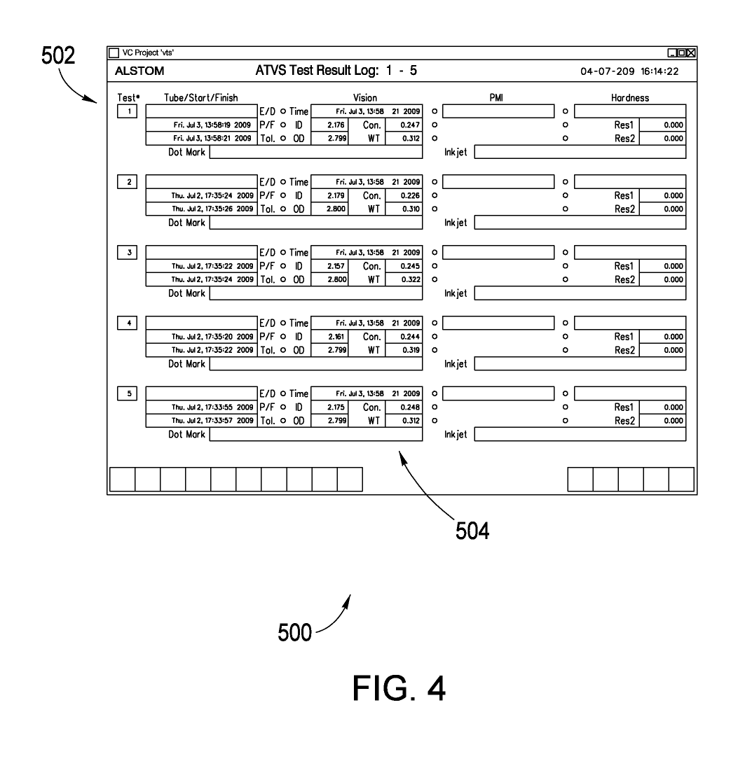

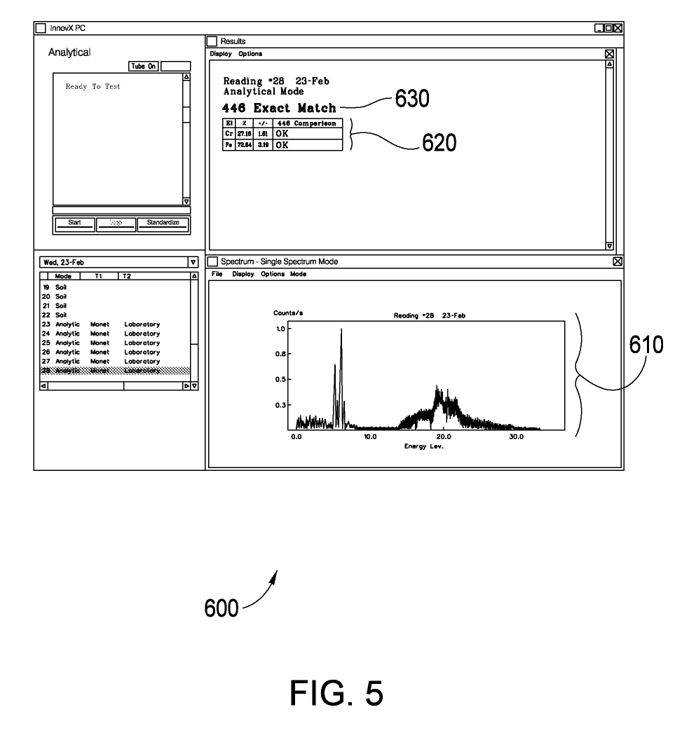

As described herein, in one embodiment the processor 122 monitors and controls progress through the verification system 100. Accordingly, the processor 122 is operatively coupled to the equipment 146, 154, 164, 174, 182 and 216 at each of the respectively test/inspection sections 140, for example, via a data bus 128 or other communication means including wired and wireless connection between components of the equipment. In one embodiment, the processor 122 exhibits various information, data and statuses of operations and procedures being performed within the verification system 100 to, for example, the operator, administrator or other persons interested in performance of the system 100, via reports or displays provided on the user interface 124 of the display device 126, or like output device such as a printer or electronic messaging system. In one embodiment the reports and displays may provide status (e.g., “pass” or “fail”) of the one or more procedures conducted at the test/inspection sections 140. For example, as shown in FIG. 4, the user interface 124 may exhibit a log or report 500 providing an on-going status of tests and/or procedures 502 pending and/or performed, procedures completed successfully, measured versus initial data values 504, estimated time for completion of an in-process procedure being performed, a complete or partial time estimate for performance of a series of procedures, and the like. As shown in FIG. 5, the user interface 124 may exhibit a report 600 providing results of the procedures for measuring and comparing properties of the tubes 20. For example, at 610, measured values of a material identification testing procedure (e.g., spectral analysis) are exhibited in the report 600. At 620, results are exhibited of the comparison of the measured values to one or both of the requisite values for the predefined acceptable properties or the initial properties. At 630 a determined “pass” or “fail” decision (e.g., “Exact Match” determination) of the material identification testing procedures is exhibited. It should be appreciated one or more of the aforementioned plurality of test, measurement and inspection stations 150, may include reports similar to the report 600.

In one embodiment, the processor 122 oversees and determines the following criterion within the verification system 100.

1) If equipment is to be used during a test procedure, for example, determine a test Enable/Disable condition.

2) Determine whether equipment is available to perform its task, for example, initiate and monitor subcomponent diagnostics.

3) Configure the equipment required to perform a test/inspection procedure at one or more of the test/inspection stations 140, for example, by loading operational instructions or control data values to the equipment.

4) Initiate a test/inspection procedure. The initiation may include, for example, providing steps of the procedure to the station and/or operator at one of the test/inspection stations 140 and/or activating pre-established test procedure(s).

5) Monitor performance of the equipment as the procedure is being carried out, determining and/or addressing routine delays or errors such as, for example, an equipment “busy” signal or “timeout” conditions.

6) Monitor performance of the entire procedure and determined that each task within the procedure has completed successfully or has otherwise been accounted for within the system 100.

7) Provide and/or retrieve test data values from the equipment.

8) Validate the test data values against the expected values (e.g., the initial properties and/or tolerances) and initiate “pas s”/“fail” procedures.

9) Store status information, in-process and final test data values in the data store 194.

Accordingly, some perceived advantages and benefits of the automated verification system 100 as described herein include, for example, providing:

1) An integrated environment for performing test/inspection procedures at one time such as, for example, at receipt of components and/or raw materials to provide time and cost savings.

2) An environment for ensuring consistency in applying test/inspection procedures such that conformance determinations can be made with less reliance on human interaction and thus the opportunity for introducing inadvertent errors or measurement variations.

3) An environment that captures important data values of properties of the components and/or raw material as soon as possible in the production process. The captured data values provide an archive or history of the components and/or raw material that may be referenced after the manufacturing or production process to, for example, investigate problems or deficiencies, or qualify/quantify performance measurements, during operational stages.

Unless otherwise specified, all ranges disclosed herein are inclusive and combinable at the end points and all intermediate points therein. The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item. All numerals modified by “about” are inclusive of the precise numeric value unless otherwise specified.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for qualifying a component, the method comprising:
receiving a component;
assigning, by a processor, an unique identifier to the component;
verifying properties of the component at one or more of a plurality of test, measurement and inspection stations to qualify the component for use, the verifying step including at least one of:
verifying physical properties of the component by visually observing properties of the component at a vision testing station, by comparing the observed properties to predefined physical ones of the properties, and by determining conformance between the observed properties and the predefined physical properties;
verifying compositional properties of the component by measuring elemental composition of material comprising the component at a material identification station, by comparing the measured elemental composition to predefined compositional ones of the properties, and by determining conformance between the measured elemental composition and the predefined compositional properties; and
verifying resistance properties of the component by measuring resistance properties of the component at a material resistance testing station, by comparing the measured resistance properties to predefined resistance ones of the properties, and by determining conformance between the measured resistance and the predefined resistance properties;
recording, in a data store, the at least one measured physical, compositional and resistance properties and results of the comparing and determining steps; and
marking, at a marking station, the component with the unique identifier.

2. A method according to claim 1, wherein the method further includes automatically transporting, by control of the processor, the component between each of the plurality of test, measurement and inspection stations and the marking station.

3. A method according to claim 1, wherein the receiving step further includes recording in the data store the predefined properties of the component.

4. A method according to claim 1, wherein the compositional properties include elemental composition of the component.

5. A method according to claim 1, wherein the resistance properties include one or more of material hardness and tensile strength of the component.

6. A system for qualifying a component, comprising:
a receiving station that receives a component;
a control section having a processor, the processor assigns an unique identifier to the component;
a plurality of test/inspection stations coupled to the control section, the plurality of test/inspection stations including equipment to measure one or more of physical, compositional and resistance properties of the component, the processor and the equipment cooperate to compare the measured properties to predefined properties and to determine conformance between the measured properties and the predefined properties to qualify the component for use;
a data storage section coupled to the control section, the data storage section having a data store, the data store receives and stores the predefined properties, the unique identifier, and the measured properties of the component; and
a marking station coupled to the control section, the marking station having marking equipment to mark the component with the unique identifier.

7. A system according to claim 6, further comprising a transport section coupled to the control section, the transport section having material transport equipment coupled to and controlled by the processor to transport the component from and between the receiving station, the plurality of test/inspection stations and the marking station.

8. A system according to claim 6, wherein the processor and the equipment cooperate to compare the measured properties to at least one of the predefined properties and initial properties of the component, and deviations in values within tolerance ranges, to determine conformance of the component and to qualify the component for use.

9. A system according to claim 8, wherein the control section further includes an output device coupled to the processor, the output device exhibits information, data and status of operations at the plurality of test/inspection stations.

10. A system according to claim 9, wherein the output device exhibits a status of at least one of pass and fail to indicate that the component conforms and is qualified for use.

11. A system according to claim 6, wherein the equipment at the plurality of test/inspection stations includes a system for measuring elemental composition of material of the component.

12. A system according to claim 6, wherein the equipment at the plurality of test/inspection stations includes a system for measuring at least one of material hardness and tensile strength of the component.
